(19) United States
(12) Patent Application Publication
(10) Pub. No.: US 2017/0208430 A1
(43) Pub. Date: Jul. 20, 2017

(54) CAR ENTERTAINMENT CONTROL SYSTEM

(71) Applicant: Panasonic Automotive Systems Company of America, Division of Panasonic Corporation of North America, Peachtree City, GA (US)

(72) Inventor: YASUHIRO TSUCHIDA, OSAKA (JP)

(73) Assignee: Panasonic Automotive Systems Company of America, Division of Panasonic Corporation of North America

(21) Appl. No.: 15/411,572

(22) Filed: Jan. 20, 2017

Related U.S. Application Data
(60) Provisional application No. 62/281,069, filed on Jan. 20, 2016.

(51) Int. Cl. H04W 4/00; H04W 4/02; H04W 76/02

(52) U.S. Cl. CPC H04W 4/008; H04W 76/023; H04W 4/027

(57) ABSTRACT

A method of pairing a smartphone to a head unit in a motor vehicle includes determining whether the smartphone is in motion by use of an accelerometer within the smartphone. A first signal is transmitted from the head unit to the smartphone. A first RSSI is received from the head unit. The first RSSI is indicative of a strength of the first signal. A second signal is transmitted from the head unit to the smartphone. A second RSSI is received from the head unit. The second RSSI is indicative of a strength of the second signal. Pairing between the smartphone and the head unit is initiated only if it was determined that the smartphone is in motion, the second RSSI is greater than the first RSSI, and the second RSSI is greater than a threshold value.

CROSS-REFERENCED TO RELATED APPLICATIONS

This application claims benefit of U.S. Provisional Application No. 62/281,069 filed on Jan. 20, 2016, which the disclosure of which is hereby incorporated by reference in its entirety for all purposes.

### FIELD OF THE INVENTION

The disclosure relates to pairing a smartphone with a head unit in a motor vehicle.

### BACKGROUND OF THE INVENTION

Using Bluetooth to connect a head unit with a smartphone is known. However, initiation of a Bluetooth connection (referred to as “pairing”) is complex for users who are not technically savvy because the user has to dive deep into the menus of the head unit and smartphone. In current Bluetooth pairing, the user has to find the Bluetooth setting menu from both the smartphone and the head unit. The user initiates the pairing by following instructions on the head unit display screen. However, the process is not easy for a person who is not technically savvy, even if the person is not the user but rather is the salesperson of the car. Finding Bluetooth settings and performing pairing are all performed manually. The user has to perform Bluetooth pairing by manually finding the setting screen and following the directed operations.

### SUMMARY

The present invention may provide a very easy method of pairing for Bluetooth or for any method of personal area networking (PAN). A smartphone may need only to be placed close to the head unit to begin pairing by utilizing Bluetooth low energy, or by utilizing a PAN method without the need for pairing to communicate. Bluetooth low energy is already commonly embedded generally in smartphones and head units. The invention provides a very easy method of pairing without the need for special hardware. Only general PAN hardware like Bluetooth and Bluetooth low energy is needed.

The invention may enable pairing to be initiated by just moving the smartphone close to the head unit. The user moving the smartphone close to the head unit may be detected by use of Bluetooth low energy (LE), and possibly by use of an accelerometer, by calculating the distance from the smartphone to the head unit by performing the following steps. First, the head unit emits a Bluetooth LE advertising packet with RSSI (received signal strength indicator), which is a value indicative of the radio field strength. Second, the smartphone receives the advertising packet and calculates the distance by use of the RSSI value. Third, if the distance is less than a threshold value (e.g., 10 centimeters), then the smartphone initiates pairing.

In the case of Bluetooth LE, the RSSI value may be more than −60 dB if the distance is less than one meter, and may be about −30 dB if the distance is almost zero. However, the RSSI value is adversely affected by other devices emitting magnetic waves (e.g., WiFi, or other devices' Bluetooth transmissions). Because of the magnetic wave weakness of Bluetooth LE, it is relatively easy to calculate that a device is within one meter but it is difficult to calculate the distance to the nearest centimeter by use of RSSI. Thus, the invention may recognize when the smartphone gets close to the head unit by utilizing not only Bluetooth LE RSSI, but also by utilizing an accelerometer.

In one embodiment, the invention comprises a method of pairing a smartphone to a head unit in a motor vehicle, including determining whether the smartphone is in motion by use of an accelerometer within the smartphone. A first signal is transmitted from the head unit to the smartphone. A first RSSI is received from the head unit. The first RSSI is indicative of a strength of the first signal. A second signal is transmitted from the head unit to the smartphone. A second RSSI is received from the head unit. The second RSSI is indicative of a strength of the second signal. Pairing between the smartphone and the head unit is initiated only if it was determined that the smartphone is in motion, the second RSSI is greater than the first RSSI, and the second RSSI is greater than a threshold value.

In another embodiment, the invention comprises a method of pairing a smartphone to a head unit in a motor vehicle. It is determined whether the smartphone is in motion by use of an accelerometer within the smartphone. A first RSSI is received from the head unit. The first RSSI is indicative of a strength of a first signal. The receiving of the first RSSI is dependent upon the determining step. A second RSSI is received from the head unit. The second RSSI is indicative of a strength of a second signal. Pairing between the smartphone and the head unit is initiated only if the second RSSI is greater than the first RSSI, and the second RSSI is greater than a threshold value.

In yet another embodiment, the invention comprises a method of pairing a head unit to a smartphone in a motor vehicle, including receiving at the smartphone a first signal from the head unit. A first RSSI indicative of a strength of the first signal is transmitted from the head unit. A second signal from the head unit is received at the smartphone. A second RSSI indicative of a strength of the second signal is transmitted from the head unit. Pairing between the head unit and the smartphone is initiated only if it has been determined by use of an accelerometer within the smartphone that the smartphone has been in motion between a first time at which the first RSSI was transmitted and a second time at which the second RSSI was transmitted, the second RSSI is greater than the first RSSI, and the second RSSI is greater than a threshold value.

### BRIEF DESCRIPTION OF THE DRAWINGS

A better understanding of the present invention will be had upon reference to the following description in conjunction with the accompanying drawings.

FIG. 1 is a schematic diagram of one example embodiment of an automotive entertainment control system of the present invention.

FIG. 2 is a flow chart of one embodiment of an automotive entertainment control method of the present invention.

FIG. 3 is a plot of RSSI versus distance.

FIG. 4 is a schematic diagram illustrating a pairing process.

FIG. 5 is a plot of RSSI versus time.

FIG. 6 is a schematic diagram illustrating a pairing process using an accelerometer.

FIG. 7 is a schematic diagram illustrating another pairing process using an accelerometer.

FIG. 8 is a flow chart of the pairing process of FIG. 7.

FIG. 9 is a flow chart of a method of the present invention for pairing a smartphone to a head unit in a motor vehicle.

### DETAILED DESCRIPTION OF THE PREFERRED EMBODIMENTS

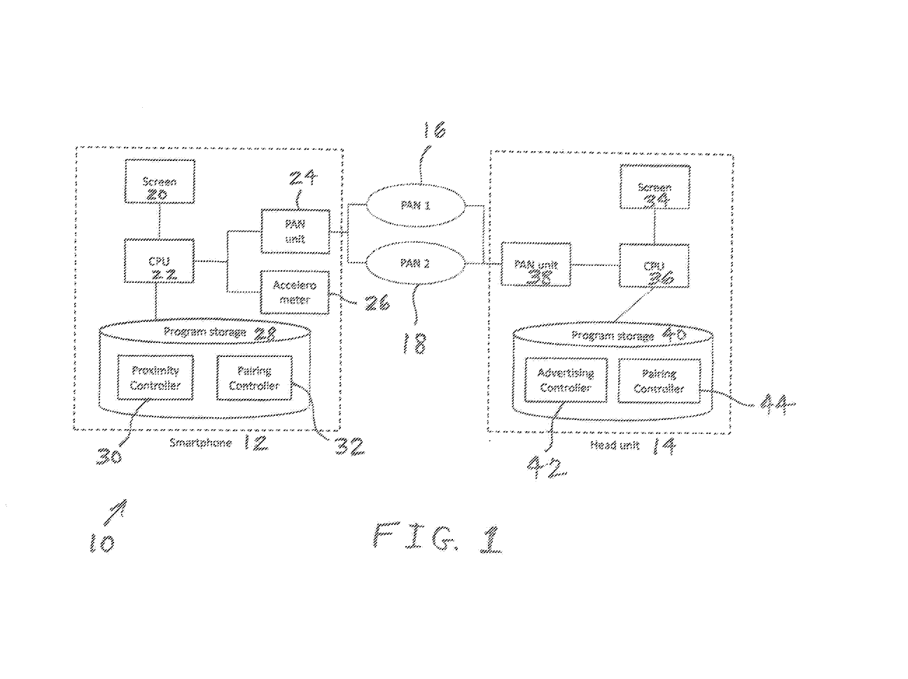

FIG. 1 illustrates one embodiment of an automotive entertainment control system 10 of the present invention, including a smartphone 12 connected to a head unit 14 by a first personal area network (PAN) 16 and a second personal area network (PAN) 18. Smartphone 12 includes a display screen 20, a central processing unit (CPU) 22, a PAN unit 24, an accelerometer 26, and program storage 28 including a proximity controller 30 and a pairing controller 32. Head unit 14 includes a display screen 34, a central processing unit (CPU) 36, a PAN unit 38, and program storage 40 including an advertising controller 42 and a pairing controller 44.

PAN 16 is a personal area network with no need for pairing in order to carry communications between smartphone 12 and head unit 14. For example, PAN 16 may be in the form of Bluetooth LE. PAN 16 provides a very convenient way to communicate between smartphone 12 and head unit 14 without needing a complex initiation to establish communication. However, PAN 16 may enable communication of only very small amounts of information (e.g., less than 32 bytes)

PAN 18 is a personal area network that does need pairing in order to carry communications between smartphone 12 and head unit 14. For example, PAN 18 may be in the form of classic Bluetooth (e.g., higher energy Bluetooth). PAN 18 may be used to exchange massive amounts of information (e.g., audio/video stream) between smartphone 12 and head unit 14, such as the application of hands-free profile (HFP) or advanced audio distribution profile (A2DP) protocol. PANs 16, 18 may be independent from each other.

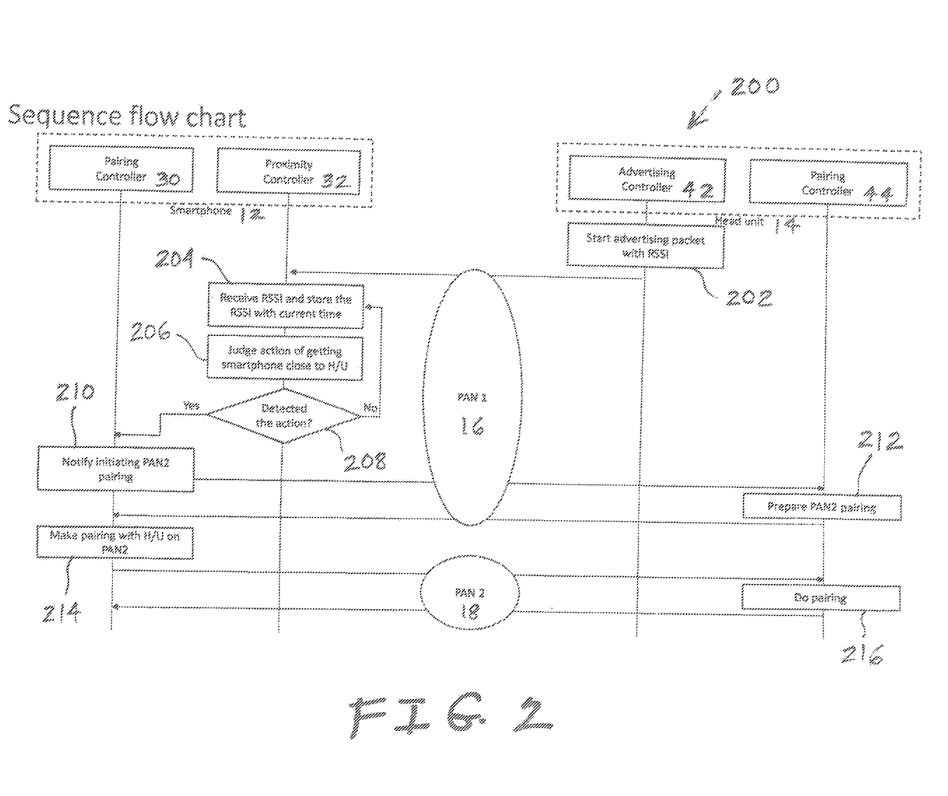

FIG. 2 is a flow chart of one embodiment of an automotive entertainment control method 200 of the present invention. In a first step 202, advertising controller 42 transmits an advertising packet with RSSI. Next, in step 204, proximity controller 32 receives the RSSI and stores the RSSI with the current time. In steps 206, 208, it is determined, based on the RSSI value, whether smartphone 12 has been moved close to head unit 14. If not, then the RSSI continues to be monitored in step 204. If so, then in step 210 pairing controller 30 notifies pairing controller 44 through PAN 16 that pairing via PAN 18 should be initiated. In response, in step 212, pairing controller 44 prepares for pairing through PAN 18. Finally, in steps 214, 216, pairing controllers 30, 44 pair smartphone 12 and head unit 14 on PAN 18.

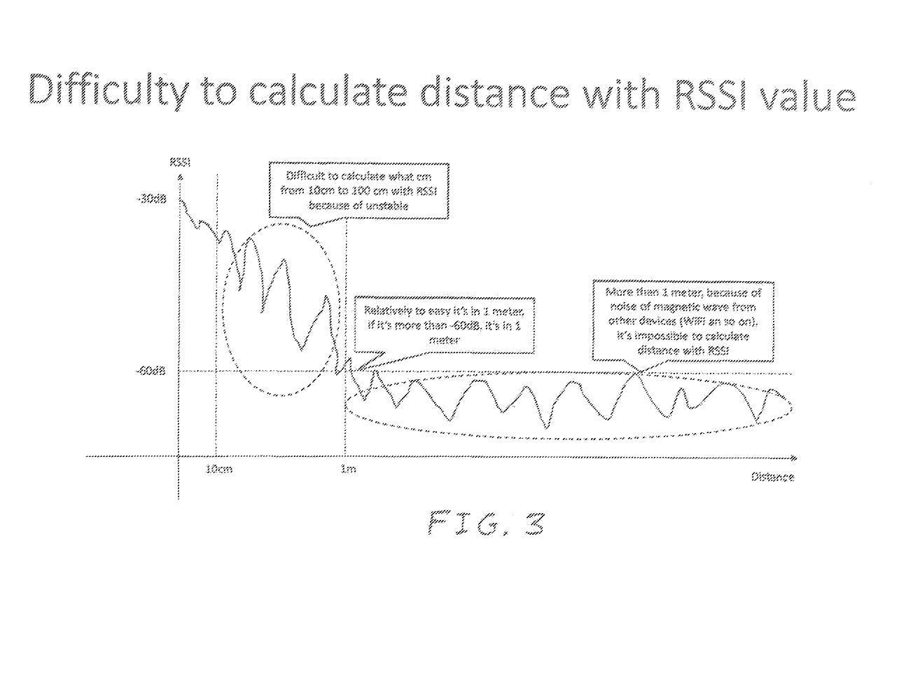

FIG. 3 is a plot of RSSI versus distance between smartphone 12 and head unit 14. At distances between 10 cm and one meter, the RSSI value is unstable, making it a poor and imprecise indication of distance. However, the RSSI value is a good and reliable indication of the distance being greater than one meter, as the RSSI value is generally above −60 dB. The RSSI value may not be a good differentiator between a distance of one meter and much larger distances, however, because of noise received from other devices at distances over one meter.

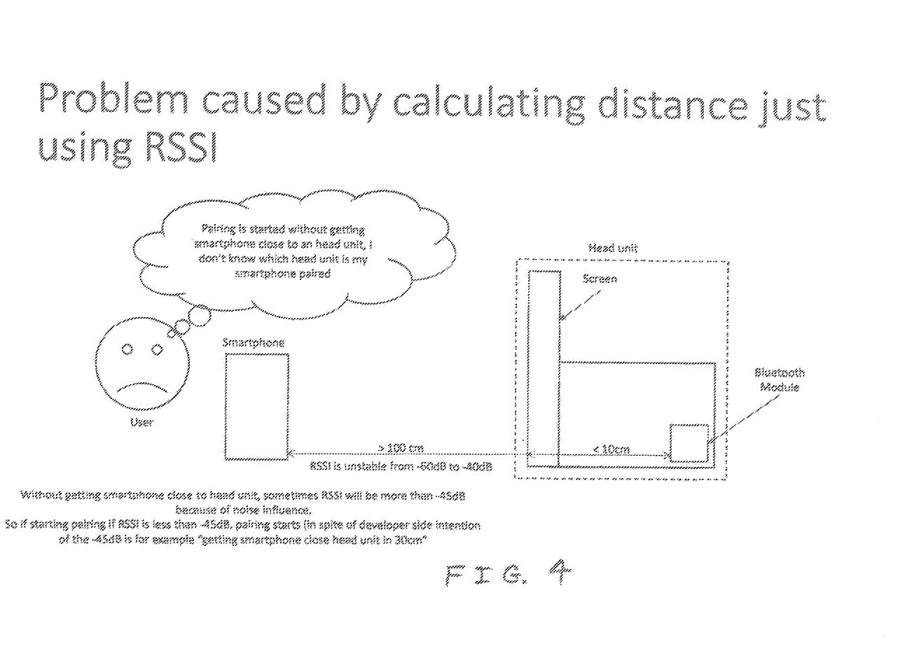

FIG. 4 is a schematic diagram illustrating a pairing process in which pairing is initiated if the smartphone just gets close to the head unit. For example, if pairing is begun in response to RSSI exceeding −45 dB, then, as shown in FIG. 3, pairing may begin when the distance is close to one meter. If pairing occurs at such large distances, then the user may not know which head unit the smartphone has been paired to.

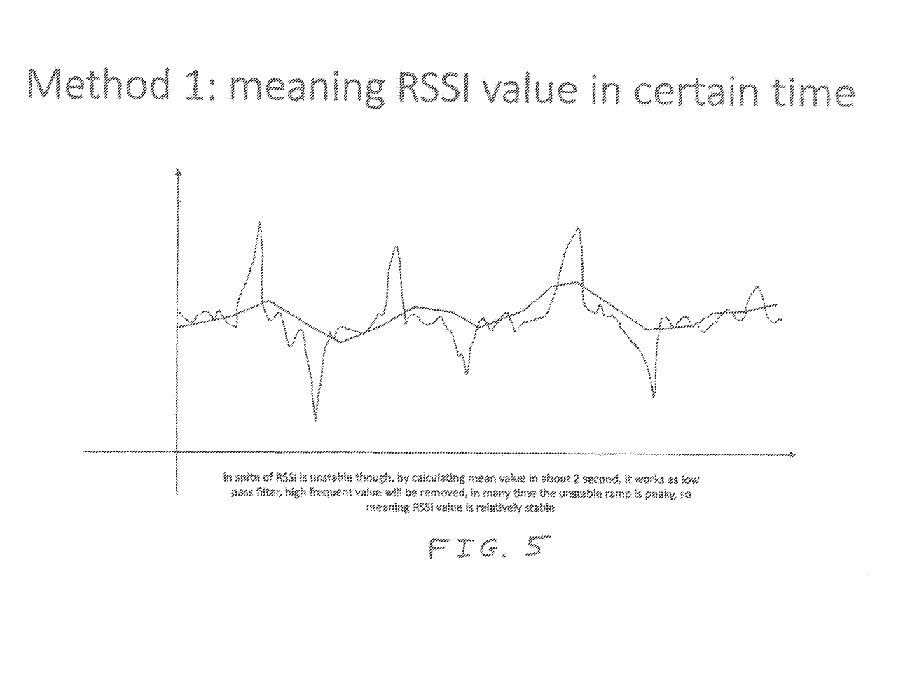

FIG. 5 is a plot of RSSI versus time. The lower frequency plot represents a mean value of RSSI over the past two seconds, as calculated in two second intervals. As can be seen, the mean value is much more stable than is the raw RSSI data.

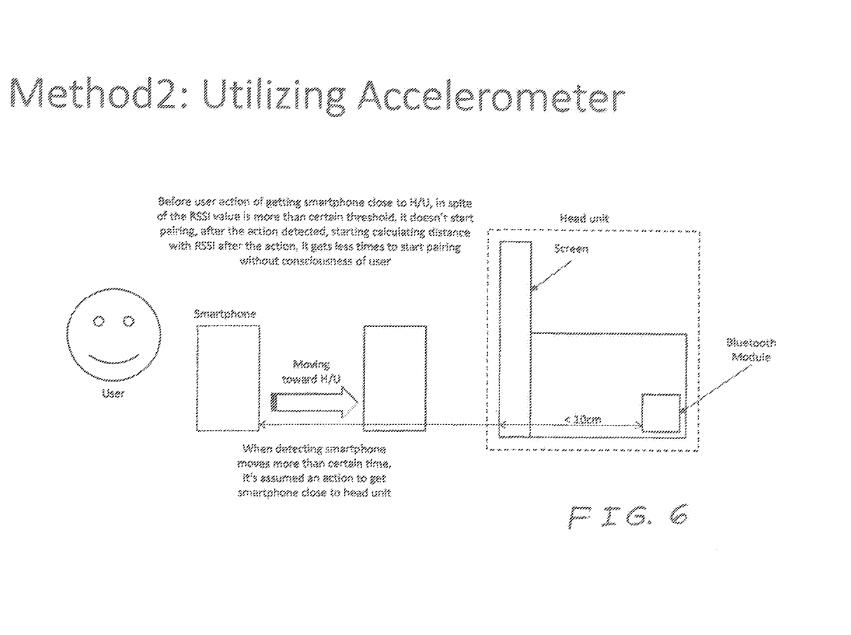

FIG. 6 is a schematic diagram illustrating a pairing process using accelerometer 26. In response to accelerometer 26 indicating that smartphone 12 has been moving for longer than a threshold period of time, it may be assumed that smartphone 12 is being moved toward head unit 14. Accordingly, monitoring of the RSSI value begins immediately, rather than waiting for the next scheduled time that RSSI is to be measured and recorded. Thus, pairing may occur more quickly than it would without the use of accelerometer 26.

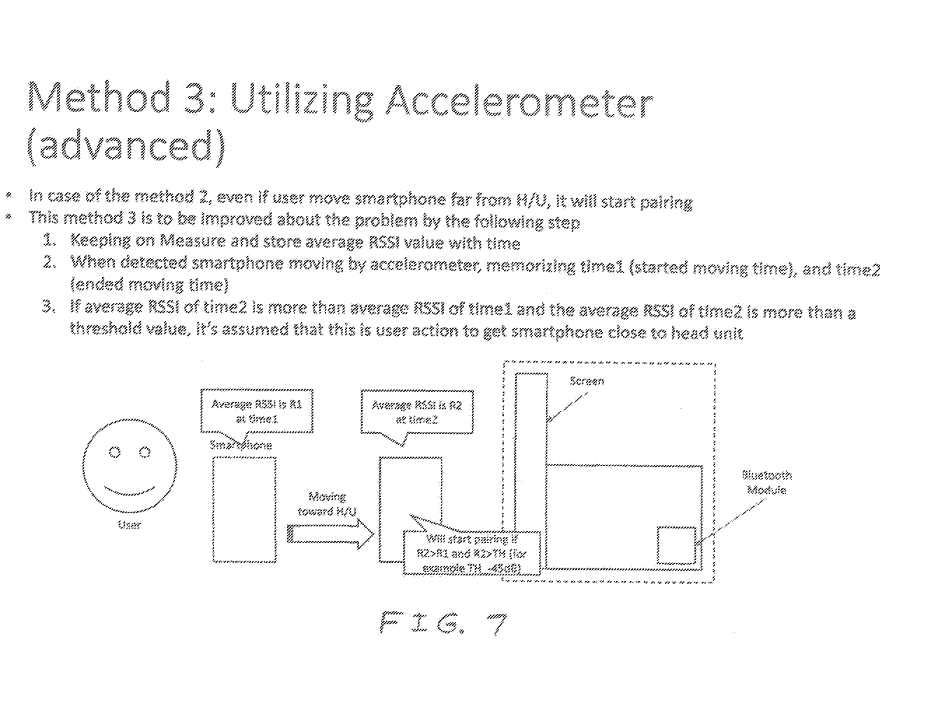

FIG. 7 is a schematic diagram illustrating another pairing process using an accelerometer. In the process of FIG. 6, even if the user moves smartphone 12 away from head unit 14, the pairing process may begin. In the process of FIG. 7, however, the average RSSI value may be measured and stored in regular time intervals. In response to accelerometer 26 indicating that smartphone 12 is moving, a first time at which smartphone 12 begins moving, and a second time at which smartphone 12 stops moving, are recorded (e.g., stored in memory). If the average RSSI at the second time is greater than the average RSSI at the first time, and the average RSSI at the second time is greater than a threshold value, then it may be ascertained that the user is moving smartphone 12 toward and close to head unit 14, and the pairing process may be initiated.

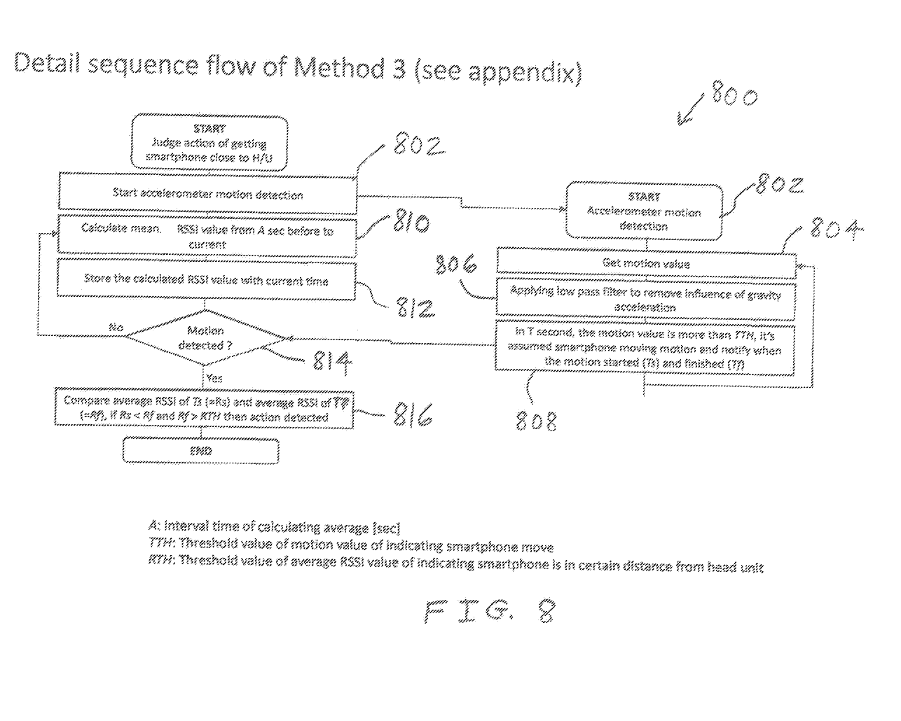

FIG. 8 is a flow chart of the pairing process 800 of FIG. 7, and is a detailed process flow chart of process 206 in FIG. 2. In a first step 802, motion detection of smartphone 12 by use of accelerometer 26 is begun, and a motion value is obtained in step 804. In step 806, a low pass filter is applied to the accelerometer readings to remove the effects of gravity acceleration. Also, a noise reduction filter may be applied by calculating an average of recent accelerometer readings. In step 808, after T seconds, if the filtered accelerometer reading is greater than TTH (a threshold value of accelerometer readings indicative of the smartphone moving), then it is assumed that the smartphone is moving. The times at which motion starts (Ts) and ends (Tf) are noted and recorded.

Possibly in parallel with the accelerometer-based smartphone motion detection, in step 810, a mean RSSI value is calculated over a past predetermined time period. In step 812, the calculated mean RSSI value is stored in memory in association with the current time. If smartphone motion is not detected in steps 808 and 814, then steps 810, 812 may be repeated until smartphone motion is detected in steps 808 and 814. Then, in a final step 816, the mean RSSI value at time Ts (Rs) is compared to the mean RSSI value at time Tf (Rf). If Rs<Rf and Rf>RTH, wherein RTH is a threshold mean value of RSSI indicating that the smartphone is within a predetermined distance of the head unit, then it is determined that the smartphone has been moved close enough to the head unit for pairing to be initiated.

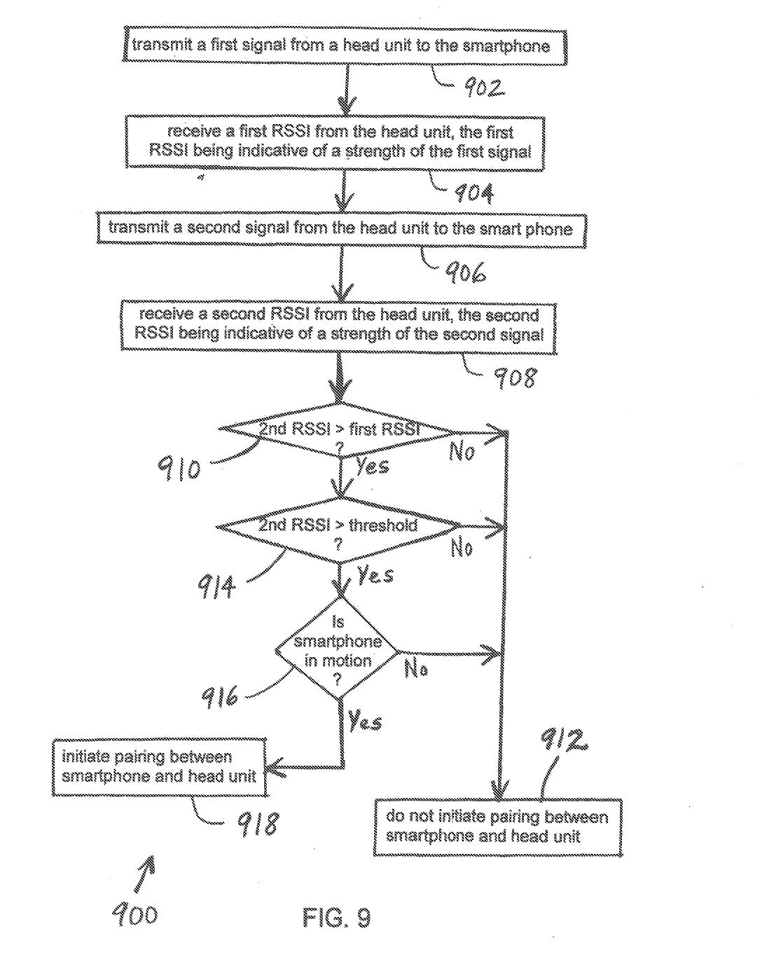

FIG. 9 is a flow chart of a method 900 of the present invention for pairing a smartphone to a head unit in a motor vehicle. In a first step 902, a first signal is transmitted from a head unit to a smartphone. For example, advertising controller 42 of head unit 14 may transmit an advertising packet with RSSI to proximity controller 32 of smartphone 12. Next, in step 904, a first RSSI is received from the head unit, the first RSSI being indicative of a strength of the first signal. For example, proximity controller 32 of smartphone 12 may receive the RSSI, which is indicative of the strength of the first signal. In step 906, a second signal is transmitted from the head unit to the smart phone. For example, advertising controller 42 of head unit 14 may transmit a second advertising packet with RSSI to proximity controller 32 of smartphone 12. Next, in step 908, a second RSSI is received from the head unit, the second RSSI being indicative of a strength of the second signal. For example, proximity controller 32 of smartphone 12 may receive the second RSSI, which is indicative of the strength of the second signal.

In step 910, it is determined whether the second RSSI is greater than the first RSSI. If not, operation proceeds to step 912 where pairing between the smartphone and the head unit is not initiated. If so, then in step 914 it is determined whether the second RSSI is greater than a threshold value. If not, operation proceeds to step 912 where pairing between the smartphone and the head unit is not initiated. If so, then in step 916 it is determined whether the smartphone is in motion by use of an accelerometer within the smartphone. For example, accelerometer 26 may sense whether smartphone 12 is moving. If not, operation proceeds to step 912 where pairing between the smartphone and the head unit is not initiated. If so, then in step 918 pairing between the smartphone and the head unit is initiated.

In steps 902 and 904, and/or steps 906 and 908, an average value of RSSI may be used instead of using just one RSSI value. By using an average value of RSSI rather than a raw RSSI value, the deleterious effects of noise in the RSSI signal may be mitigated.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A method of pairing a smartphone to a head unit in a motor vehicle, the method comprising:
determining whether the smartphone is in motion by use of an accelerometer within the smartphone;
transmitting a first signal from the head unit to the smartphone;
receiving a first RSSI from the head unit, the first RSSI being indicative of a strength of the first signal;
transmitting a second signal from the head unit to the smart phone;
receiving a second RSSI from the head unit, the second RSSI being indicative of a strength of the second signal; and
initiating pairing between the smartphone and the head unit only if:
it was determined that the smartphone is in motion;
the second RSSI is greater than the first RSSI; and
the second RSSI is greater than a threshold value.

2. The method of claim 1 wherein the second RSSI is received after the first RSSI is received.

3. The method of claim 1 wherein the pairing is initiated between the smartphone and the head unit only if it was determined by use of the accelerometer that the smartphone is in motion.

4. The method of claim 1 wherein the threshold value is indicative of the smartphone being within one meter of the head unit.

5. The method of claim 1 comprising the further step of completing the pairing via a personal area network.

6. The method of claim 1 wherein communication between the smartphone and the head unit before pairing is carried by Bluetooth LE, and is carried by Bluetooth classic during pairing.

7. The method of claim 1 wherein the first RSSI is in a first advertising packet, and the second RSSI is in a second advertising packet.

8. The method of claim 1 wherein the first RSSI is an average of a plurality of RSSI values recorded over a first period of time, and the second RSSI is an average of a plurality of RSSI values recorded over a second period of time.

9. A method of pairing a smartphone to a head unit in a motor vehicle, the method comprising:
determining whether the smartphone is in motion by use of an accelerometer within the smartphone;
receiving a first RSSI from the head unit, the first RSSI being indicative of a strength of a first signal, the receiving of the first RSSI being dependent upon the determining step;
receiving a second RSSI from the head unit, the second RSSI being indicative of a strength of a second signal; and
initiating pairing between the smartphone and the head unit only if:
the second RSSI is greater than the first RSSI; and
the second RSSI is greater than a threshold value.

10. The method of claim 9 wherein the first RSSI is transmitted by the head unit in response to determining that the smartphone is in motion by use of an accelerometer within the smartphone.

11. The method of claim 10 wherein the second RSSI is transmitted by the head unit a predetermined time period after the first RSSI is transmitted by the head unit.

12. The method of claim 9 wherein the determining step includes low pass filtering an output of the accelerometer.

13. The method of claim 9 wherein the threshold value is indicative of the smartphone being within 30 centimeters of the head unit.

14. A method of pairing a head unit to a smartphone in a motor vehicle, the method comprising:
receiving at the smartphone a first signal from the head unit;
transmitting from the head unit a first RSSI indicative of a strength of the first signal;
receiving at the smartphone a second signal from the head unit;
transmitting from the head unit a second RSSI indicative of a strength of the second signal; and
initiating pairing between the head unit and the smartphone only if:
it has been determined by use of an accelerometer within the smartphone that the smartphone has been in motion between a first time at which the first RSSI was transmitted and a second time at which the second RSSI was transmitted;
the second RSSI is greater than the first RSSI; and
the second RSSI is greater than a threshold value.

15. The method of claim 14 wherein the second RSSI is transmitted after the first RSSI is transmitted.

16. The method of claim 14 wherein the threshold value is indicative of the smartphone being within 60 centimeters of the head unit.

17. The method of claim 14 comprising the further step of completing the pairing via a personal area network.

18. The method of claim 14 wherein communication between the smartphone and the head unit before pairing is carried by Bluetooth LE, and is carried by Bluetooth classic during pairing.

19. The method of claim 14 wherein the first RSSI is in a first advertising packet, and the second RSSI is in a second advertising packet.

20. The method of claim 14 wherein the first RSSI is an average of a plurality of RSSI values recorded over a first period of time, and the second RSSI is an average of a plurality of RSSI values recorded over a second period of time.
